(19) United States
(12) Patent Application Publication
(10) Pub. No.: US 2025/0293889 A1
(43) Pub. Date: Sep. 18, 2025

(54) OCCURRENCE COUNT STORAGE

(71) Applicant: Arm Limited, Cambridge (GB)

(72) Inventors: Lorenzo DI GREGORIO, Gauting (DE); Andrew David TUNE, Dronfield (GB)

(21) Appl. No.: 18/745,036

(22) Filed: Jun. 17, 2024

(30) Foreign Application Priority Data
Mar. 14, 2024 (GB) 2403724.4

(51) Int. Cl. H04L 9/32

(52) U.S. Cl. CPC H04L 9/3236; H04L 9/3247

(57) ABSTRACT

There is provided an apparatus comprising hash circuitry to generate hash values from a set of values, and signature storage circuitry to store signature data indicative of a subset of the hash values. The signature storage circuitry is responsive to receipt of a hash value that falls within a range defined based on the subset, to retain the hash value in the subset and to discard a member of the subset. The signature storage circuitry is configured, when the hash value does not fall within the dynamically varying range, to discard the hash value. The signature storage circuitry is configured to store an occurrence count indicative of repeat occurrences of each stored hash value. The apparatus is provided with calculation circuitry to estimate a frequently occurring portion of the values based on stored hash values for which the occurrence count meets a condition.

### CROSS-REFERENCE TO RELATED APPLICATION

This application claims priority to GB Application No. 2403724.4 filed Mar. 14, 2024, the entire contents of which are hereby incorporated by reference.

### TECHNICAL FIELD

The present invention relates to data processing. More particularly the present invention relates to an apparatus, a method, a system, a chip containing product, and a non-transitory computer-readable medium.

### BACKGROUND

Some apparatuses may be provided with calculation circuitry to provide estimates relating to sets of values. Such estimates may be calculated, based on one or more hashed subsets of those values.

### SUMMARY

According to a first aspect of the present techniques there is provided an apparatus comprising:
hash circuitry configured, in response to receipt of a set of values, to generate a set of hash values;
signature storage circuitry configured to store signature data indicative of a subset of the set of hash values, wherein the signature storage circuitry is responsive to receipt of a hash value of the set of hash values:
   when the hash value falls within a dynamically varying range defined at least in part based on the subset, to retain the hash value in the subset and to discard an existing member of the subset; and
   when the hash value does not fall within the dynamically varying range, to discard the hash value,
wherein the signature storage circuitry is configured to store, for each stored hash value of the subset, an occurrence count indicative of a number of repeat occurrences of the stored hash value that occur in the set of hash values during a period in which the stored hash value is retained in the subset; and
calculation circuitry configured to calculate an estimate of a frequently occurring portion of the set of values based on stored hash values for which the occurrence count meets a predetermined condition.

According to a second aspect of the present techniques there is provided an apparatus comprising:
hash circuitry configured, in response to receipt of a set of values, to generate a set of hash values;
signature storage circuitry configured to store first signature data indicative of a first subset of the set of hash values during a first access window and second signature data indicative of a second subset of the hash values during a second access window, wherein during each respective access window of the first and second access windows the signature storage circuitry is responsive to receipt of a hash value of the set of hash values:
   when the hash value falls within a dynamically varying range defined at least in part based on the respective subset, to retain the hash value in the respective subset and to discard an existing member of the respective subset; and
   when the hash value does not fall within the dynamically varying range, to discard the hash value; and
calculation circuitry configured to calculate an estimate of a recently occurring portion of the set of values based on comparison of the first signature data and the second signature data,
wherein a start of the second access window begins after a start of the first access window and at least a portion of the second access window overlaps with the first access window.

According to a third aspect of the present techniques there is provided a system comprising:
the apparatus of the first aspect or the second aspect, implemented in at least one packaged chip;
at least one system component; and
a board,
wherein the at least one packaged chip and the at least one system component are assembled on the board.

According to a fourth aspect of the present techniques there is provided a chip-containing product comprising the system the third aspect, wherein the system is assembled on a further board with at least one other product component.

According to a fifth aspect of the present techniques there is provided a method comprising:
generating, in response to receipt of set of values, a set of hash values;
storing signature data indicative of a subset of the set of hash values, wherein storing comprises, in response to receipt of a hash value of the set of hash values:
   when the hash value falls within a dynamically varying range defined at least in part based on the subset, retaining the hash value in the subset and discarding an existing member of the subset; and
   when the hash value does not fall within the dynamically varying range, discarding the hash value,
storing, for each stored hash value of the subset, an occurrence count indicative of a number of repeat occurrences of the stored hash value that occur in the set of hash values during a period in which the stored hash value is retained in the subset; and
calculating an estimate of a frequently occurring portion of the set of values based on stored hash values for which the occurrence count meets a predetermined condition.

According to a sixth aspect of the present techniques there is provided a non-transitory computer-readable medium storing computer-readable code for fabrication of the apparatus of the first aspect or the second aspect.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates a measure of cardinality according to some configurations of the present techniques;

FIG. 3 schematically illustrates size estimation according to some configurations of the present techniques;

FIG. 4 schematically illustrates an apparatus according to some configurations of the present techniques;

FIG. 5 schematically illustrates a sequence of steps carried out according to some configurations of the present techniques;

FIG. 6 schematically illustrates an apparatus according to some configurations of the present techniques;

FIG. 7 schematically illustrates a sequence of steps carried out according to some configurations of the present techniques;

FIG. 8 schematically illustrates an apparatus according to some configurations of the present techniques;

FIG. 9 schematically illustrates a sequence of steps carried out according to some configurations of the present techniques;

FIG. 10 schematically illustrates a sequence of steps carried out according to some configurations of the present techniques; and

FIG. 11 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations there is provided an apparatus. The apparatus is provided with hash circuitry configured, in response to receipt of a set of values, to generate a set of hash values. The apparatus is also provided with signature storage circuitry configured to store signature data indicative of a subset of the set of hash values. The signature storage circuitry is responsive to receipt of a hash value of the set of hash values: when the hash value falls within a dynamically varying range defined at least in part based on the subset, to retain the hash value in the subset and to discard an existing member of the subset; and when the hash value does not fall within the dynamically varying range, to discard the hash value. The signature storage circuitry is configured to store, for each stored hash value of the subset, an occurrence count indicative of a number of repeat occurrences of the stored hash value that occur in the set of hash values during a period in which the stored hash value is retained in the subset. The calculation circuitry is configured to calculate an estimate of a frequently occurring portion of the set of values based on stored hash values for which the occurrence count meets a predetermined condition.

The set of hash values may be any values and may be distributed in any manner. For example, the hash values may be 8-bit, 16-bit, or 32-bit values and may be evenly distributed or may be grouped within a space of all possible values. The hash circuitry is configured to generate the hash values by applying a hashing algorithm to the values. Each value of the set of values maps to a single hash value. However, a same hash value may be generated by multiple different values. The hash algorithm may be chosen so that the hash values are evenly distributed in a space of all possible hash values. In this way a set of un-evenly distributed values may be mapped to an evenly distributed set of hash values.

The apparatus is arranged to calculate an estimate of the frequently occurring portion, i.e., a size of a group of the values that are seen to have an occurrence count meeting the predetermined condition. For example, the apparatus may be configured to count the size of the group of values having an occurrence count greater than 1, 2, 3, etc within a window of a given size. The inventors have recognised that the frequently occurring portion can be calculated based on analysis of a stored subset of the hash values. In particular, the apparatus is provided with signature storage circuitry that stores hash values falling within a dynamically varying range. The dynamically varying range is further defined base on the subset of stored hash values. The dynamically varying range is described in further detail below. By studying the subset of hash values that are stored in the signature storage circuitry statistical measurements applicable to the set of values can be calculated based on that subset of hash values. The measurements can be inferred to approximate the same measurements if such measurements were to be made to the entire set of values. Considering only a subset of the hash values reduces the overall storage requirements and the need to compare new hash values with all previous hash values. By incorporating the occurrence count with each of the stored hash values, the calculation circuitry is able to recognise stored hash values which have been generated frequently. This information extends the statistical information that is stored and enables the calculation circuitry to estimate the frequently occurring portion.

The occurrence count may be provided as a single or multi-bit counter associated with each stored hash value. For example, a single bit counter may be provided that is set to a first value when a hash value is added to the subset, and may be set to a second value when a further value is added. In this way the single bit can be used to indicate that the same stored hash value has been identified multiple times. In other configurations, the counter is a multi-bit counter configured to provide a finer grained indication of a number of times that hash value has been received. The estimate of the frequently occurring portion is calculated based on the hash values for which the occurrence count meets a predetermined condition. For example, those hash values having a counter exceeding or equal to a predefined value at the end of an access window may be considered to be frequently occurring. The signature data can therefore be indicative of members of the set of values that have been observed (e.g., one or more times) and also indicative of members of the set of values that have been observed more frequently (e.g., plural times).

Whist an estimate of the frequently occurring portion could be provided based on a comparison of those members of the subset of the hash values meeting the predetermined condition and all members in the subset of hash values, in some configurations the signature data is second signature data, the subset is a second subset, and the second signature data is stored during a second access window; the signature storage circuitry is configured to store first signature data indicative of a first subset of the set of hash values during a first access window; and the calculation circuitry is configured to calculate the estimate based on comparison of the first signature data and the second signature data. The first and second subset provide an indication of the set of values received during the first and second windows respectively. The first signature data is indicative of hash values observed during the first window and the second signature data is indicative of hash values observed during the second window. Hence, by comparison of the first and second signature data, an estimate of the frequently occurring portion can be obtained in which the frequently occurring portion is also indicative of those members of the set of values that have been observed at least once during a first access window and that have been subsequently and frequently observed during a second access window. This approach introduces control over the timing of the measurements and provides improved flexibility.

Whilst the first and second access windows can be defined in any manner, for example as occurring sequentially or consecutively, in some configurations a start of the second access window begins after a start of the first access window and at least a portion of the second access window overlaps with the first access window. Overlapping the first and second access windows increases the likelihood that there will be some hash values in the first signature data that are also in the second signature data providing an improved estimate of the occurrence count. In some configurations the second access window falls entirely within the first access window. In some configurations the first access window and the second access window end at a same point (e.g., a same time, on receipt of a same value, or on a same clock cycle). In some configurations, the first access window is a continuous access window running from a start point to a reset point, and the second access window is one of a plurality of consecutive or sequential access windows with measurements of the frequently occurring portion updated at the end of each second access window.

In some configurations the first signature data is independent of a number of repeat occurrences of hash values retained in the first subset. In other words, whilst the number of repeat occurrences is stored for the second signature data, the first signature data may not store this information. The first signature data is therefore indicative of values that have been observed during the first window but does not store any indication of whether those values have been seen one time or more than one times.

In some configurations the estimate is based on an intersection size of an intersection of the second subset of hash values for which the occurrence count meets the predetermined condition and the first subset of hash values. Calculating an intersection size between the first signature data and the second signature data allows for an estimate to be obtained indicative of a number of values observed in the first window that are also observed (and also frequently observed) in the second access window. This approach extends the MinHash algorithm in which signature data across two sequential access windows is compared to determine hash values that occur in both the first signature data and the second signature data. Including information indicative of the occurrence count provides an extension that enables a frequently observed portion of the values to be estimated. Whilst it would be theoretically possible to calculate the similarity between the first signature and the second signature using arbitrary first and second access windows by calculating a ratio of the intersection of values included in the first and second subsets to a union of the first and second subsets, this approach can be inaccurate if the intersection of the first signature data and the second signature data is close to zero. Instead, in configurations in which the first access window and the second access window overlap, the likelihood of a non-zero intersection is greatly increased because all hash values that are observed during the second access window are also observed during the first access window. In addition, for configurations in which the second access window falls entirely within the first access window, the union of the first access window and the second access window can be calculated as the size of the first access window (which may be set, e.g., hardwired, in the circuitry).

In some configurations the apparatus is provided with cardinality estimation circuitry configured to calculate a cardinality estimate of the set of values, wherein the estimate comprises multiplying the cardinality estimate by a ratio of the intersection size and a size of the first subset. The cardinality of a set (e.g., the set of values) is a measure of the number of elements of the set. Calculating the exact cardinality of a large set can require significant storage circuitry and processing power due to the need to store previously observed members of the set such that it can be determined if a received member of the set is a newly observed member of the set (e.g., one which was not seen before) or if it is a repeat occurrence of a previously observed member of the set (e.g., one which has been seen before). The cardinality estimation circuitry therefore does not attempt to calculate an exact measure of the cardinality of the set of values but instead provides an estimate of the size of the set of values. Whilst it will be readily apparent to the skilled person that any cardinality estimation algorithm could be used, in some configurations, the cardinality estimation circuitry uses the HyperLogLog algorithm. The HyperLogLog algorithm is based on the observation that the cardinality of a set of uniformly distributed random numbers can be estimated by calculating the maximum number of leading zeros in the binary representation of each number in the set. If the maximum number of leading zero is n then the number of distinct elements in the set can be estimated to be 2ⁿ. By applying the HyperLogLog algorithm to the set of hash values it is therefore possible to estimate the cardinality. In general, the HyperLogLog algorithm could also be performed by calculating the maximum number of leading ones, or more generally, by calculating the maximum number of leading ones or zeros observed in a difference between the hash value and a fixed value. In other words, the HyperLogLog algorithm effectively estimates how close one of the received values falls to a fixed value. For a 32 bit randomly distributed set of values, the likelihood that any one predetermined value will be received is one in 2³². It is much more likely that any one random value that is received will be far from the predetermined fixed value. Therefore, if a value is received that is close to the predetermined value then it is likely that the set of values is very large (e.g., it is more likely that value close to the predetermined value was not one of a small set of values received by random chance, but because the cardinality of the set is so large that it is likely that one of the large set of values is close to the predetermined value). In practise the HyperLogLog algorithm can be implemented using a set of registers to store a set of hash values (samples) from which the cardinality can be estimated. Combining the cardinality estimate with the ratio of the intersection size and the size of the first subset allows the size of the frequently observed portion to be obtained. In some alternative configurations, the CVM algorithm for estimating distinct elements in streams could be used.

In some configurations the cardinality estimation circuitry is configured to calculate a first cardinality estimate at the start of the second access window, and a second cardinality estimate at the end of the second access window; and the calculation circuitry is configured to estimate a number of newly received values based on a difference between the first cardinality estimate and the second cardinality estimate. The first cardinality estimate provides an indication of the size of the set of values at the start of the second access window (e.g., part way through the first access window). The second cardinality estimate provides an indication of the size of the set of values at the end of the second access window (e.g., also at the end of the first access window). Subsequent to obtaining the first cardinality estimate, the values obtained may include values already observed and values that have not been previously observed. The difference between the first cardinality estimate and the second cardinality estimate therefore provides an approximation of the number of newly received (newly observed) values.

In some configurations the signature storage circuitry is configured to discard a plurality of hash values based on the number of newly received values; and a number of hash values discarded is based on the number of newly received values divided by the second estimate of cardinality. The signature storage circuitry is provided with a finite amount of storage space and may only store k different hash values, where k is an integer. Because the signature storage circuitry stores hash values that fall within the dynamically varying range which is itself based at least in part on the subset of hash values, the signature storage circuitry can become saturated (full) with hash values that are no longer frequently occurring. In order to reduce the likelihood that frequently occurring hash values could be missed, the signature storage circuitry is configured to discard values at the end of the second access window. This frees up space in the signature storage circuitry for subset access windows. The number of hash values to be discarded is estimated based on the number of newly received values. In some configurations the hash values that are evicted are the hash values that are furthest from one or both of the boundaries of the dynamically varying range.

In addition, or as an alternative, to the eviction of hash values based on the number of newly received values, in some configurations the signature storage circuitry is configured to evict hash values based on a comparison between the occurrence count and a threshold for each one of the hash values. In order to provide the estimate of the frequently occurring portion, the signature storage circuitry is configured to store the signature data indicative of the subset of the hash values for which the occurrence count indicates that the hash values have been frequently observed. Evicting hash values based on a comparison between the occurrence count and a threshold allows the stored values to be refreshed and helps prevent the signature data being filled with hash values that are no longer frequently observed.

In some configurations the apparatus is provided with an access counter, wherein the signature storage circuitry is configured to store, for each stored hash value of the subset, a snapshot of the access counter, wherein the calculation circuitry is configured, for each one of the hash values, to perform the comparison based on a difference between the access counter and the snapshot for that one of the hash values. The comparison therefore takes into account both the number of occurrences of the hash value and the duration (e.g., the number of accesses) for which the hash value has been indicated in the signature data.

In some configurations the signature storage circuitry is configured to evict hash values for which a ratio between the occurrence count and a difference between the snapshot and the access counter is less than the threshold. The difference between the snapshot and the access counter provides an indication of a number of counts for which the hash value has been stored in the signature storage circuitry. The ratio of the occurrence count and the number of counts for which the hash value has been stored in the signature storage circuitry provides an estimate of the frequency of occurrence of the hash value. A hash value that is initially observed frequently will be unlikely to be evicted. However, as the access counter increases the ratio will decrease thereby increasing the likelihood that, unless a further occurrence of the hash value is observed, the hash value will be evicted.

In some configurations evicting hash values comprises setting the hash value to one of: a predetermined constant, the predetermined constant numerically furthest outside of the dynamically varying range; and an invalid value. The signature data may also be initialised by setting all hash values within the signature storage circuitry to one of the predetermined constant and the invalid value.

Whilst the set of values can be any set of values, in some configurations the set of values is a set of accessed memory addresses, and the frequently occurring portion is a set of frequently accessed memory addresses. In such configurations, the apparatus may be configured to calculate a size of a frequently accessed working set (otherwise referred to as the hot working set). The frequently accessed working set provides an estimate of the size of the set of frequently accessed addresses. This is in contrast to a working set size which is a size of the set of all addresses that have been observed, and is in contrast to an active working set size which is a size of the set of all addresses that have been observed in the working set and that also occur during a further access window. The frequently accessed working set may be useful for estimating cache size allocation and/or other storage requirements.

In some configurations at least one of an upper bound and a lower bound of the dynamically varying range is defined based on an extremum of the subset. The extremum of the subset may be a maximum of the subset or a minimum of the subset. In some configurations the other of the upper bound and the lower bound may be defined based on a predetermined fixed value. For example, the dynamically varying range may vary between a minimum possible hash value and a maximum value within the subset. In such configurations, the subset contains the q minimum hash values (the bottom q hash values), where q is the size of the subset. In other configurations, the dynamically varying range may vary between a maximum possible hash value and a minimum value within the subset. In such configurations the subset contains the q maximum hash values.

In some configurations the existing member of the subset is the extremum of the subset. In such configurations, the range of the dynamically varying subset is changed each time a new member is added to the subset and the hash value that defined the previous bound of the dynamically varying range is evicted. In some configurations the other one of the upper bound and the lower bound is defined based on an extremum of all possible hash values.

In some configurations there is provided an apparatus comprising hash circuitry configured, in response to receipt of a set of values, to generate a set of hash values. The apparatus is also provided with signature storage circuitry configured to store first signature data indicative of a first subset of the set of hash values during a first access window and second signature data indicative of a second subset of the hash values during a second access window. During each respective access window of the first and second access windows the signature storage circuitry is responsive to receipt of a hash value of the set of hash values, when the hash value falls within a dynamically varying range defined at least in part based on the respective subset, to retain the hash value in the respective subset and to discard an existing member of the respective subset. In addition, during each respective access window of the first and second access windows the signature storage circuitry is responsive to receipt of the hash value of the set of hash values, when the hash value does not fall within the dynamically varying range, to discard the hash value. The apparatus is also provided with calculation circuitry configured to calculate an estimate of a recently occurring portion of the set of values based on comparison of the first signature data and the second signature data. A start of the second access window begins after a start of the first access window and at least a portion of the second access window overlaps with the first access window.

In such configurations, the signature storage circuitry stores signature data during first and second access windows. The first signature data and the second signature data are each indicative of hash values that have been received in the respective first and second access windows. The inventors have recognised that by arranging the access windows such that the first and second access windows overlap with one another, there is a reduced likelihood that an intersection of hash values comprised in the first and second signature will be zero. As a result, the accuracy of the estimate of the recently occurring portion is increased compared to a case in which there is no overlap between the first access window and the second access window. In some configurations, the estimate of the recently occurring portion is also an estimate of a frequently occurring portion. In some configurations the second access window is completely contained in the first access window.

Particular configurations will now be described with reference to the figures.

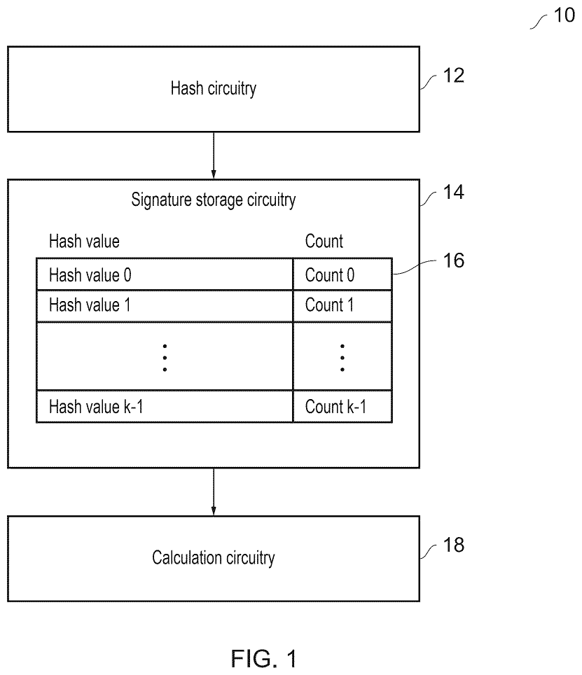

FIG. 1 schematically illustrates an apparatus 10 according to some configurations of the present techniques. The apparatus 10 is provided with hash circuitry 12, signature storage circuitry 14, and calculation circuitry 18. The hash circuitry 12 is responsive to receipt of a set of values to generate hash values which are passed to the signature storage circuitry 14. The signature storage circuitry 14 receives the set of hash values generated by the hash circuitry 12 and determines whether the received hash value falls within a dynamically varying range. The dynamically varying range is defined at least in part based on a subset of hash values 16 stored in the signature storage circuitry 14. When the received hash value is determined to fall within the dynamically varying range, the signature storage circuitry 14 retains the hash value in the subset of hash values 16 and evicts an existing hash value from the subset of hash values 16. When the received hash value is determined to fall outside of the dynamically varying range, the signature storage circuitry 14 discards the hash value. In addition to storing the subset of hash values 16, the signature storage circuitry 14 is configured to store an occurrence count indicative of a number of repeat occurrences of the stored hash value. In the illustrated configurations, hash value 0 has an occurrence count of Count 0, hash value 1 has an occurrence count of Count 1, and hash value k−1 has an occurrence count of Count k−1. The calculation circuitry 18 is configured to calculate an estimate of a frequently occurring portion of the set of values based on the stored set of hash values 16. In particular, the calculation circuitry 18 basis the estimate on those hash values 16 in the stored set of hash values 16 for which the occurrence count meets a predetermined condition.

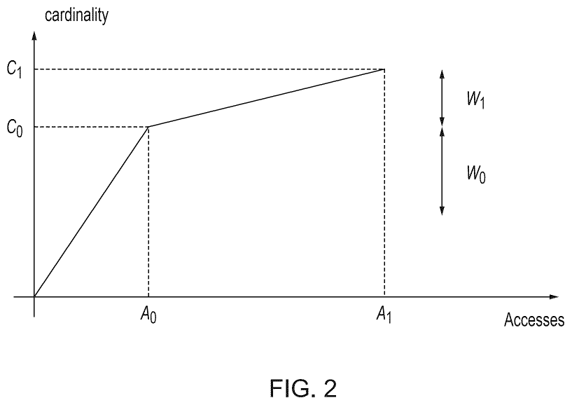

FIG. 2 schematically illustrates the principle of calculating the active working set size. It is noted that the active working set size is defined as the size set of values that are in the working set of values (the total set of observed values) and that have been observed to occur within a recent access window. The hot working set size is the subset of the active working set that has been visited at a rate (frequency) higher than a given bound. The graph in FIG. 2 illustrates a cardinality of a set of values observed during an access period. Two access period are illustrated, the period from 0 to A₀ and the period from A₀ to A₁.

During the access period from 0 to A₀ a number of accesses occur and a cardinality of values seen in those access increases from 0 to C₀. During the access period from A₀ to A₁, the cardinality increases from C₀ to C₁. The increase in cardinality is therefore equal to W₁ which is equal to C₁ minus C₀ (i.e., W₁=C₁−C₀). It is emphasised that not all accesses seen between A₀ and A₁ will necessarily result in an increase in cardinality. Rather, some accesses will be new accesses that contribute to the increase in cardinality by the amount W₁. But there will also be accesses seen in the window between A₀ and A₁ that do not increase the cardinality because they are accesses that have been previously observed either in the access window between 0 and A₀ or have been previously observed as part of the new accesses in the window between A₀ and A₁.

The active working set in the access window from A₀ to A₁ is defined as W₁ as this is the portion of the working set that has been seen more than once and with at least one of those occurrences being in the access window from A₀ to A₁. The hot working set in the access window from A₀ to A₁ is defined as the portion of the hot working set that has been seen to occur at a frequency greater than a threshold frequency within the second access window. The frequency is defined as the number of observations of that access within the access window divided by the total number of accesses since the first observation of that access within the access window. In other words, an access may be seen a small number of times near the end of the access window (e.g., multiple accesses in quick succession) and may therefore occur at a high enough frequency to exceed the threshold frequency. On the other hand, if the access had been seen to occur a small number of times near the start of the access window but did not subsequently occur, the access may not meet the frequency threshold by the end of the access window and may be discarded from the hot working set.

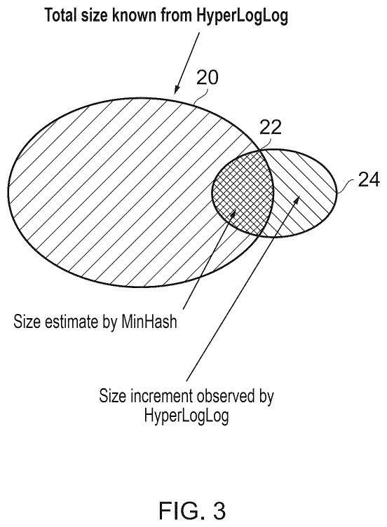

FIG. 3 schematically illustrates the concept of estimating the active working set size or the hot working set size. Values received during the access period from 0 to A₀ are illustrated in the first shaded area 20. Values received during the access period from A₀ to A₁ are illustrated in the second shaded area 24. The first shaded area 20 and the second shaded area 24 overlap with one another to create an intersecting shaded area 22. Values obtained in the intersecting shaded area 22 are values which were obtained during both the access period from 0 to A₀ and in the access period from A₀ to A₁.

During operation, the cardinality estimation circuitry estimates the total size of the set of values including the values received during both the access period from 0 to A₀ and in the access period from A₀ to A₁. In some configurations, the cardinality estimation circuitry may provide two estimates of cardinality such that the size increment of the set of values may be obtained. In the illustrated configuration, the size increment is the area included in the second shaded area 24 that is not included in the first shaded area 20.

The signature storage circuitry stores first signature data indicative of a set of values observed during both the access period from 0 to A₀ and in the access period from A₀ to A₁. The signature storage circuitry also stores second signature data indicative of a set of values obtained during the period from A₀ to A₁. An estimate of the fraction of the values observed in the access period from 0 to A₁ that also appear in the access period from A₀ to A₁ can then be obtained by comparing the first signature data and the second signature data. Mathematically, this ratio is known as the Jacquard ratio and can be expressed as

$$J = \frac{{S}_{0} ⋂ {S}_{1}}{{S}_{0} ⋃ {S}_{1}} ,$$

where S₀ is the set of values received during the period from 0 to A₀ and S₁ is the set of values received during the period from A₀ to A₁. In other words, J is equal to the intersection of S₀ and S₁ divided by the union of S₀ and S₁. According to configurations of the present techniques, the union of S₀ and S₁ is simply given by the size of S₀. The Jacquard ratio can therefore be approximated as

$$J = \frac{m}{k} ,$$

where k is the size of the sampled subset of S₀ and m is the number of hash values that are present in both of S₀ and S₁ and that have an occurrence count satisfying a predefined condition. Multiplying the Jacquard ratio by the cardinality estimation allows the size of the active working set to be approximated. The size of the hot working set can be obtained by excluding (discarding) members of S₁ that are observed at a frequency lower than a predefined threshold.

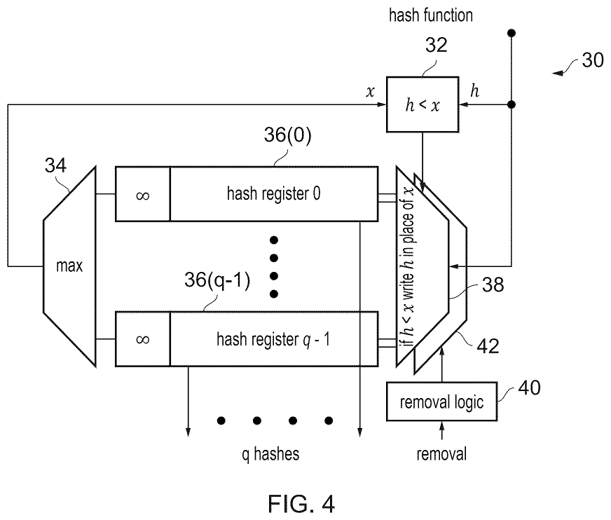

FIG. 4 schematically illustrates signature storage circuitry 30 according to some configurations of the present techniques. The signature storage circuitry 30 receives hash values and stores a signature indicative of those hash values. The signature storage circuitry 30 omits information indicative of how many occurrences of the hash values are obtained. The signature storage circuitry 30 comprises hash registers 36, de-multiplexing circuitry 34, multiplexing circuitry 38, removal multiplexing circuitry 42, removal logic 40, and comparison circuitry 40.

Hash registers 36 store a set of hash values. In general, there are q registers 36 where q is any positive integer. The de-multiplexing circuitry 34 determines the register 36 storing the largest hash value and outputs that register 36 to the comparison circuitry 32 as a value denoted x. The signature storage circuitry 30 receives a hash value h which is also passed to the comparison circuitry 32. The comparison circuitry 32 compares the values of h and x and, in particular determines if h is lower than x. Here, the comparison circuitry is determining if h falls within the dynamically varying range which is defined as having a lower limit of zero and an upper limit that is set by the value x (the largest currently stored hash value). If the comparison circuitry 32 identifies that h is lower than x, then h is passed to the multiplexing circuitry 38 which outputs the value of h to the register from which x was retrieved and h is stored in place of x. It will be appreciated that after a number of different h values are received by the signature storage circuitry 30, the signature storage circuitry will store the q smallest hash values that it has received in the registers. The signature storage circuitry is configured to output the values stored in the q registers to the calculation circuitry to calculate the frequently occurring portion (as will be described in further detail below).

The removal logic 40 is configured to identify registers 36 that are to be reset, e.g., in response to a global reset signal. The resetting may be achieved by triggering the removal multiplexing circuitry to cause the setting of the values in those registers to ∞ where here ∞ is to be understood to refer to either an invalid register value or a largest possible value that can be store in the registers.

In general hash values may be generated using multiple different hash values and the signature storage circuitry 30 may be configured with multiple sets of registers 36 along with comparison circuitry 32, de-multiplexing circuitry 34, multiplexing circuitry 38, removal logic 40, and removal multiplexing circuitry 42. The signature storage circuitry may be configured to store k different hash values, where k is equal to an integer multiple of q. The hash values are therefore generated using k/q different hashing algorithms. For example, a single hashing algorithm may be provided and, in that case, only a single instance of the set of (q=k) registers 36 along with a corresponding set of comparison circuitry 32, de-multiplexing circuitry 34, multiplexing circuitry 38, removal logic 40, and removal multiplexing circuitry 42. By way of a further example, where 4 different hashing algorithms are provided, four instances of the set of (q=k/4) registers 36 along with a corresponding set of comparison circuitry 32, de-multiplexing circuitry 34, multiplexing circuitry 38, removal logic 40, and removal multiplexing circuitry 42.

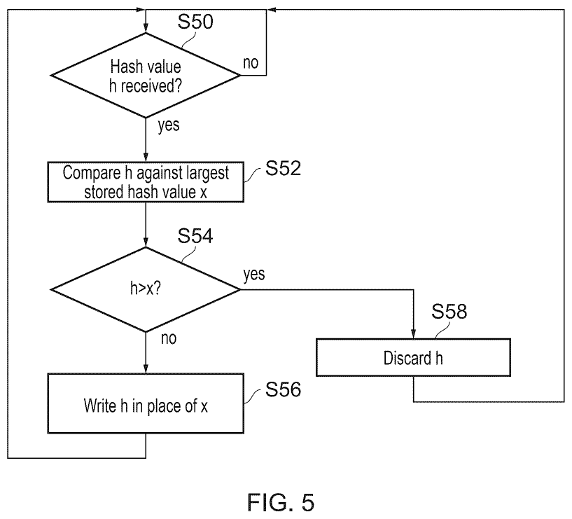

FIG. 5 schematically illustrates an operation of the signature storage circuitry 30 according to some configurations of the present techniques. Flow begins at step S50 where it is determined if a hash value h is received. If, at step S50, it is determined that no hash value has been received, then flow remains at step S50. If, at step S50, it is determined that a hash value has been received, then flow proceeds to step S52 where the hash value has is compared against the largest stored hash value x. Flow then proceeds to step S54 where it is determined if h is greater than x. If, at step S54, it is determined that h is greater than x, then flow proceeds to step S58 where h is discarded before flow returns to step S50. If, at step S54, it is determined that h is not greater than x, then flow proceeds to S56 where h is written to the registers 36 in place of x. Flow then returns to step S50.

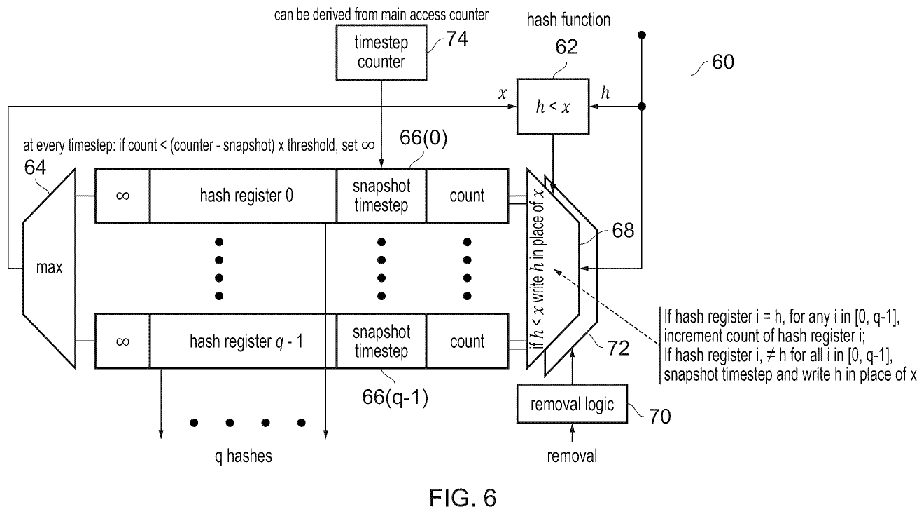

FIG. 6 schematically illustrates signature storage circuitry 60 according to some configurations of the present techniques. The signature storage circuitry 60 is provided with comparison circuitry 62, a set of registers 66, de-multiplexing circuitry 64, multiplexing circuitry 68, removal logic 70, removal multiplexing circuitry 72, and a timestep counter 74. The set of registers 66 comprises q registers, each of the q registers 66 stores a hash value, a snapshot of the timestep, and a count (occurrence count). The de-multiplexing circuitry 64 selects the register 66 having the largest hash value and outputs the value of that register 66 to the comparison circuitry 62 as a value denoted x. The comparison circuitry 62 also receives a hash value h. As an initial comparison, the signature storage circuitry 60 determines if the hash value h is already stored in any of the registers. If the hash value h is stored in one of the registers 66 then the count value stored in that register is increased. Otherwise, the signature storage circuitry 60 compares the value of h against x. If it is determined that h is less than x, then the comparison circuitry 62 triggers the multiplexing circuitry 68 to store the hash value in the register 66 from which x was retrieved. The value h is stored in place of x. In addition, the comparison circuitry 62 triggers a current value (e.g., a snapshot) of the timestep counter 74 to be stored in the register 66 and the count is reset.

The signature storage circuitry 60 further comprises removal logic 70. The removal logic and the removal multiplexer 72 operate in a similar manner to the removal logic 40 and the removal multiplexer 42 described in relation to FIG. 4. In addition, the removal logic is configured, at each time step to calculate an access frequency, the access frequency is estimated for each register 66 as the count value divided by a difference between the timestep counter 74 and the snapshot stored in that register 66. If the estimated frequency is less than a threshold, then the removal logic 70 triggers the removal multiplexer to set the hash value in that register to ∞ where here ∞ is to be understood to refer to either an invalid register value or a largest possible value that can be store in the registers. In addition, the count value may be reset. As a result, the hash values that are stored in the registers 66 comprise only hash values for which the access frequency is greater than the defined threshold.

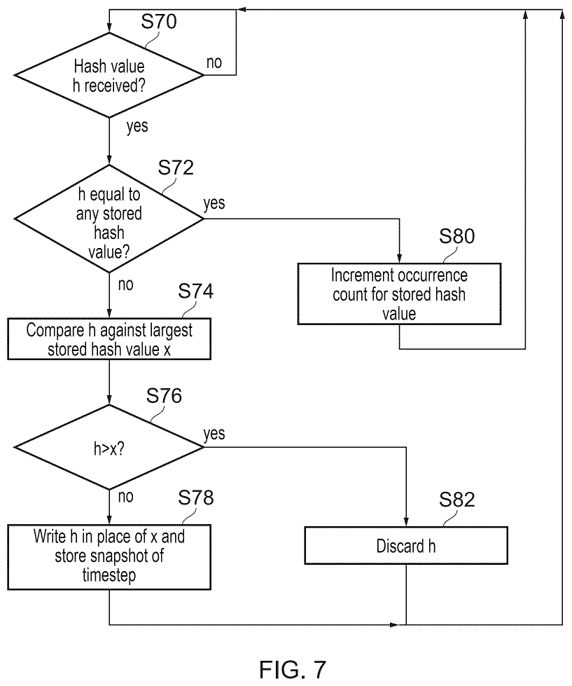

FIG. 7 schematically illustrates the operation of the signature storage circuitry 60 according to some configurations of the present techniques. Flow begins at step S70 where it is determined if a hash value has been received. If, at step S70, it is determined that a hash value has not been received, then flow remains at step S70. If, at step S70, it is determined that a hash value has been received, then flow proceeds to step S72. At step S72 it is determined whether h is equal to any of the stored hash values already present in the registers 66. If, at step S72, it is determined that h is equal to one of the stored hash values then flow proceeds to step S80 where the occurrence count for the stored hash value that is equal to h is incremented. Flow then returns to step S70. If, at step S72, it is determined that is not equal to any stored hash values, then flow proceeds to step S74, where h is compared against the largest stored hash value x. Flow then proceeds to step S76 where it is determined if h is greater than x. If, at step S76, it is determined that h is greater than x, then flow proceeds to step S82 where h is discarded before flow returns to step S70. If, at step S76, it is determined that h is not greater than x, then flow proceeds to step S78 where h is written in place of x and a snapshot of the timestep is stored. Flow then returns to step S70.

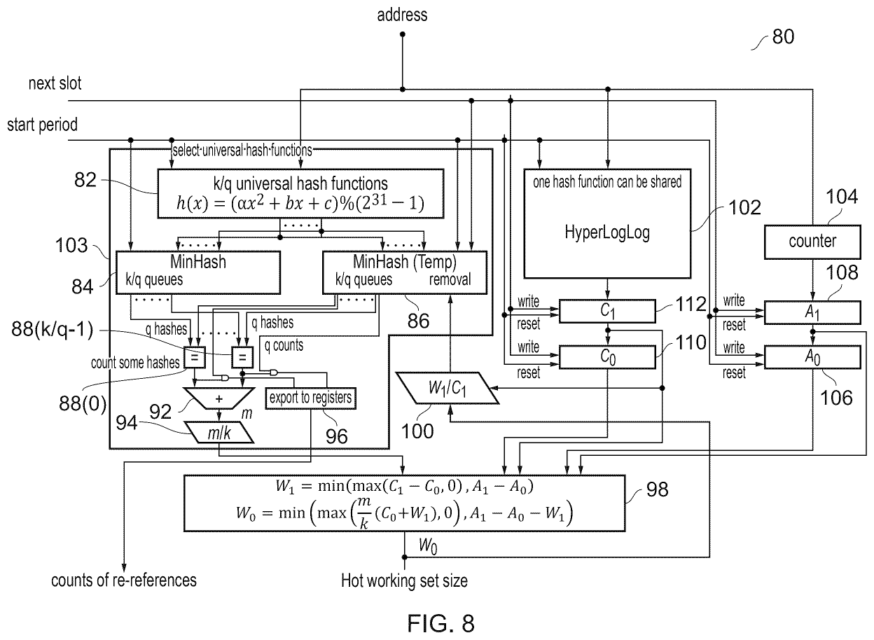

FIG. 8 schematically illustrates an example of an apparatus according to some configurations of the present techniques an apparatus 80 according to some configurations of the present techniques. The apparatus is provided with cardinality estimation circuitry 102 and Jacquard ratio estimation circuitry 103. In addition, the apparatus is provided with calculation circuitry 98, counter circuitry 104, first storage circuitry 110, second storage circuitry 112, first access window storage circuitry 106, second access window storage circuitry 108, and removal calculation circuitry 100.

The cardinality estimation circuitry 102 is configured to implement the HyperLogLog algorithm to estimate the cardinality of a set of addresses that are provided as an input to the cardinality estimation circuitry 102 along with a “start period” signal to trigger the start of the calculation procedure. The cardinality estimation circuitry continually outputs a cardinality estimate to second storage circuitry 112 which, in turn, outputs to first storage circuitry 110. The first storage circuitry 110 and the second storage circuitry 112 are configured to store a cardinality estimate C₀ which is indicative of a cardinality at the start of the second access window (i.e., at point A₀ as illustrated in FIG. 2), and a cardinality estimate C₁ which is indicative of a cardinality at the end of the second access window (i.e., at A₁ as illustrated in FIG. 2). The storage of the cardinality estimates is triggered by the “start period” signal which resets the cardinality estimates stored in the first storage circuitry 110 and the second storage circuitry 110 and the “next slot” signal which triggers the writing of the cardinality estimates. In particular, on receipt of the “next slot” signal, the cardinality estimate output from the cardinality estimation circuitry 102 is stored to the second storage circuitry 112 and the cardinality estimate that was previously stored in the second storage circuitry 112 is stored in the first storage circuitry 110. As a result, each time a “next slot” signal is received, the first storage circuitry 110 and the second storage circuitry 112 are each updated such that the first storage circuitry 110 stores the estimate of the cardinality at the beginning of the most recent access window and the second storage circuitry 112 stores the estimate of the cardinality at the end of the most recent access window.

The Jacquard ratio estimation circuitry 103 is provided with hash circuitry 82, first signature storage circuitry 84, second signature storage circuitry 86, comparison circuitry 88, summation circuitry 92, export circuitry 96, and ratio calculation circuitry 94. The hash circuitry 82 generates k/q hash values based on k/q hash functions implemented in the hash circuitry 82. Here k is the total number of hash values (for all k/q hash functions) that are stored in each of the first signature storage circuitry 84 and the second signature storage circuitry 86, and q is a size of each of the k/q queues stored in each of the first signature storage circuitry 84 and the second signature storage circuitry 86. In general k and q are defined such that k is an integer multiple of q. For each received address, the hash generation circuitry 82 generates k/q hash values (one for each of the k/q hash functions) which are passed to each of the first signature storage circuitry 84 and the second signature storage circuitry 84. The first signature storage circuitry 84 is implemented using the circuitry described in relation to FIG. 4 and stores k/q queues each comprising the q smallest hash values generated from the respective hash function. The first signature storage circuitry is reset (all stored hash values set to ∞) by the “start period” signal and continues to update the stored hash values until a next “start period” signal is received. The second signature storage circuitry 86 is implemented using the circuitry described in relation to FIG. 6 and stores k/q queues each comprising the q smallest hash values generated from the respective hash function along with timestamp information and count information associated with each of the stored hash values. The second signature storage circuitry 86 is reset (all stored hash values set to ∞) by the “start period” signal. Furthermore, a number of values are evicted from the second storage circuitry 86 in response to the “next slot” signal (as will be described in further detail below). As a result, the hash values stored in the second signature storage circuitry 86 comprise only hash values generated in the most recent access window. For each of the k/q queues stored in the first signature storage circuitry 84, the q hash values are output to comparison circuitry 88. Similarly, for each of the k/q queues stored in the second signature storage circuitry 86, q hash values are output. The q hash values that are output from the second signature storage circuitry 86 comprise the stored hash values for which the access frequency is greater than a threshold (as described in relation to FIG. 6). Comparison circuitry 88(0) receives all q hashes stored in the zeroth queue of the k/q queues from each of the first signature storage circuitry 84 and the second signature storage circuitry 86. Similarly, each comparison circuitry 88 up to the comparison circuitry 88 (k/q−1) receive all q hashes stored in the respective queue up to the (k/q−1)-th queue in each of the first signature storage circuitry 84 and the second signature storage circuitry 86. The comparison circuitry 88 is configured to count occurrences of the same hash value, i.e., to compare the hash values stored in the respective queue in each of the first signature storage circuitry 84 and the second signature storage circuitry 86. The comparison circuitry is configured to omit any of the received hash values for which the hash value is invalid or is set to co. The counted occurrences are output by each comparison circuit 88 to the summation circuitry 92 which sums the occurrence counts to calculate the total number of hash values generated by a same one of the k/q hash functions that are stored in both the first signature storage circuitry 84 and the second signature storage circuitry 86. This value, denoted m, is output to the ratio calculation circuitry 94. The counts generated by the comparison circuits 88 are also exported by the export circuitry 96 for storage and potential for subsequent analysis. The ratio calculation circuitry 94 calculates an estimate of the Jacquard ratio m/k based on the value of m received from the summation circuitry 92 and a stored (e.g., hardwired) value of k. The estimate of the Jacquard ratio is output to the calculation circuitry 98.

The counter circuitry 104 is configured to count a total number of addresses received by the apparatus 80. The counter continually outputs the total number of addresses to the second access window storage circuitry 108 which outputs to the first access window storage circuitry 106. The first access window storage circuitry 106 and the second access window storage circuitry 108 are configured to store values A₀ and A₁ respectively where A₀ is an indication of at total number of accesses at the start of the most recent access window and A₁ is the total number of accesses at the end of the most recent access window (as illustrated in FIG. 2). The values stored in first access window storage circuitry 106 and the second access window storage circuitry 108 are reset in response to the “start period” signal. On receipt of the “next slot” signal, the value output from the counter circuitry 104 is written to the second access window storage circuitry 108 and the value previously stored in the second access window storage circuitry 108 is stored in the first access window storage circuitry 106. The counter circuitry 104 is also reset in response to the “start period” signal.

The calculation circuitry 98 receives the estimate of the Jacquard ratio from the ratio calculation circuitry 94 along with values of the cardinality C₀ and C₁ that are stored in the first storage circuitry 110 and the second storage circuitry 112 respectively. The calculation circuitry 98 calculates an estimate of the number of newly received values (denoted W₁ and as illustrated in FIG. 2). The number of newly received values is equal to the difference between the second cardinality estimate C₁ and the first cardinality estimate C₀. However, the first and second cardinality estimates are not exact values and may be subject to some error, e.g., due to the statistical nature of the measurements being made, there may be some inherent inaccuracies. As a result, it may be theoretically possible that the estimate C₁ minus C₀ is a negative number (even though the exact value, if that was to be calculated, would not be). To account for this, the calculation circuitry imposes bounds on the value of W₁. In particular, W₁ is bounded from below by zero and is bounded from above by the total number of accesses in the access window (A₁ minus A₀) as stored in the first access window storage circuitry 106 and the second access window storage circuitry 108 (in other words, the number of new accesses is bounded so that it cannot exceed the total number of accesses, e.g., due to statistical errors). Hence, the number of newly received values is defined as

$${W}_{1} = min ( max ( {C}_{1} - {C}_{0} , 0 ) , {A}_{1} - {A}_{0} ) .$$

The hot working set size (i.e., the size of the frequently accessed working set) is estimated by the calculation circuitry 98 based on the Jacquard ratio estimate, received from the ratio calculation circuitry 94, and the cardinality estimates received from the first storage circuitry 110 and the second storage circuitry 112. Whilst the hot working set size could theoretically be calculated by multiplying the Jacquard ratio estimate by the cardinality estimate C₁, this approach is potentially susceptible to the statistical errors (e.g., that C₀ may be estimated to be larger than C₁). Hence, in the illustrated configuration, the cardinality estimate C₀ is used with the number of new values W₁ added to it (where W₁ is bounded from above and below as described above). As in the case of the calculation of W₁, the calculation of W₀ is bounded to prevent erroneous values being generated due to statistical errors. W₀ is bounded from below by zero (the hot working set size is prevented from being negative) and is bounded from above by the total number of accesses in the access window minus the number of new accesses. Hence, the hot working set size is estimated as

$${W}_{0} = min ( max ( \frac{m}{k} ( {C}_{0} + {W}_{1} ) , 0 ) , {A}_{1} - {A}_{0} - {W}_{1} ) .$$

The hot working set size is output by the calculation circuitry and may be used, for example, for cache allocation purposes.

The value W₁, in addition to being used in the calculation of the hot working set size, is fed back into removal calculation circuitry 100 which calculates the number of entries to be removed from the second signature storage circuitry 86 as the ratio of the number of new entries W₁ to the cardinality estimate C₁, i.e., the fraction of members of the set that comprises the new set members. The number of entries to be removed from the second storage circuitry is fed back into the second signature storage circuitry 86 to trigger removal on receipt of the next “next slot” signal.

Whilst the cardinality estimation circuitry 102 in the illustrated configuration is arranged to use the HyperLogLog algorithm, it will be readily apparent to the skilled person that any cardinality estimation algorithm could be used, for example, the CVM algorithm for estimating distinct elements in streams could be used. Furthermore, it is noted that the hashing of addresses is performed by the cardinality estimation circuitry 102, however, in alternative configurations, a global hashing function could be provided to generate hash values for both the cardinality estimation circuitry 102 and the Jacquard ratio estimation circuitry 103. Whilst the illustrated configuration bounds the estimates of W₀ and W₁ from above and below, it will be readily apparent to the skilled person that an approximation for W₀ and W₁ could also be calculated omitting these steps with (optional) additional downstream logic provided to deal with negative values of W₀ and W₁.

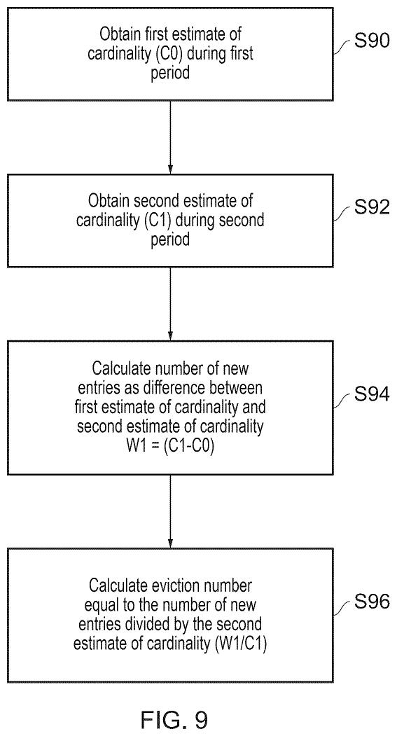

FIG. 9 schematically illustrates a sequence of steps carried out in accordance with some configurations of the present techniques. Flow begins at step S90 where an estimate of the cardinality C₀ is obtained during a first access window (first period). Flow then proceeds to S92 where a second estimate of cardinality C₁ is obtained during a second access window (second period). The first and second access windows may be overlapping access windows. Flow then proceeds to step S94 where a number of new entries is calculated as a difference between the first cardinality estimate and the second cardinality estimate (W₁=C₁−C₀). Flow then proceeds to step S96 where an eviction number equal to the number of new entries divided by the second estimate of cardinality is calculated, i.e., W₁/C₁. This number is used to trigger eviction of that many entries from the second signature storage circuitry in response to the “next slot” signal.

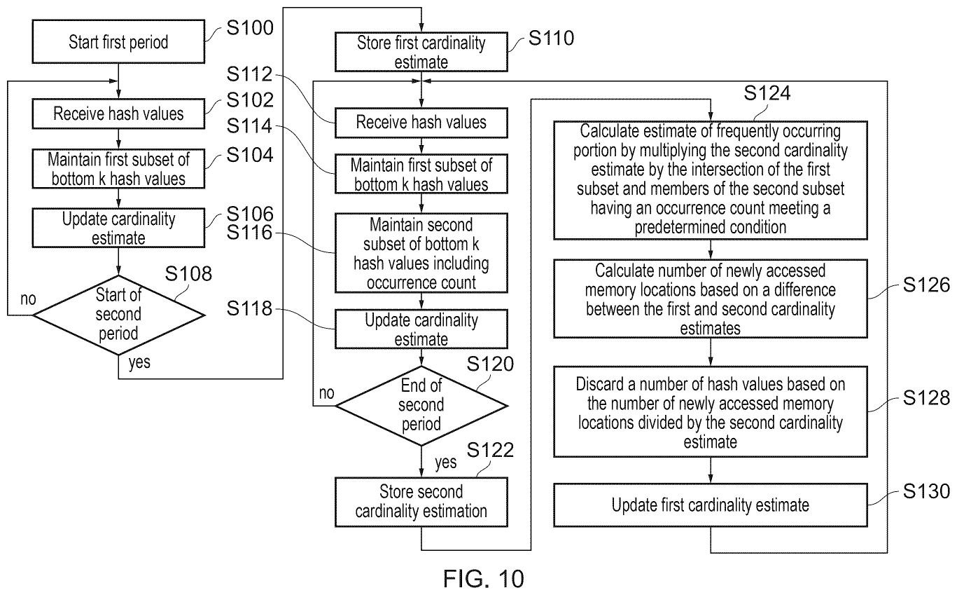

FIG. 10 schematically illustrates a sequence of steps carried out in accordance with some configurations of the present techniques. Flow begins at step S100 where the first period (first access window) is started. Flow then proceeds to step S102 where a sequence of hash values is received. The hash values may be generated globally and passed to the signature storage circuitry and the cardinality estimation circuitry. Alternatively, the cardinality estimation circuitry and the signature storage circuitry may each be provided with their own hash generation circuitry. Flow then proceeds to step S104 where a first subset of the bottom k hash values is stored, i.e., the first signature data comprising the hash values that fall within the dynamically varying range is stored. Flow then proceeds to step S106 where the cardinality estimate is updated. Flow then proceeds to step S108 where it is determined if the second period (second access window) has started. If, at step S108, it is determined that the second period has not started, then flow returns to step S102. If, at step S108, it is determined that the second period has started, then flow proceeds to step S110. At step S110 the first cardinality estimate is stored before flow proceeds to step S112. At step S112 further hash values are received. Flow then proceeds to step S114 where the first subset of bottom k hash values is maintained (e.g., the first signature data is updated). Flow then proceeds to step S116 where the second subset of bottom k hash values (the second signature data) is updated including occurrence count information associated with each of the stored hash values. Flow then proceeds to step S118 where the cardinality estimate is updated. Flow then proceeds to step S120 where it is determined if the second period has ended. If, at step S120, it is determined that the second period has not ended, then flow returns to step S112. If, at step S120, it is determined that the second period has ended, then flow proceeds to step S122. At step S122 the second cardinality estimation is stored. Flow then proceeds to step S124 where an estimate of the frequently occurring portion is calculated by multiplying the second cardinality estimate by the intersection of the first subset and members of the second subset having an occurrence count meeting a predetermined condition. Flow then proceeds to step S126 where a number of newly accessed memory locations is calculated based on a difference between the first and second cardinality estimates. Flow then proceeds to step S128 where a number of hash values are discarded based on the number of newly accessed memory locations divided by the second cardinality estimate. Flow then proceeds to step S130 where the first cardinality estimate is updated, e.g., it is set equal to the current second cardinality estimate. Flow then returns to step S112 to obtain an updated estimate of the frequently occurring portion over a subsequent second access window.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

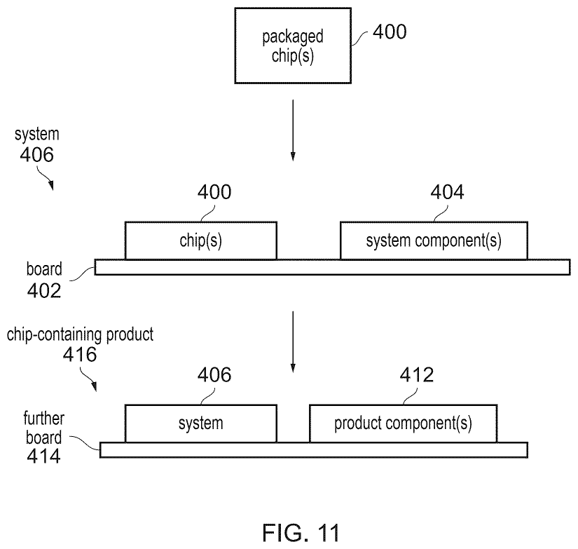

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising hash circuitry to generate hash values from a set of values, and signature storage circuitry to store signature data indicative of a subset of the hash values. The signature storage circuitry is responsive to receipt of a hash value that falls within a range defined based on the subset, to retain the hash value in the subset and to discard a member of the subset. The signature storage circuitry is configured, when the hash value does not fall within the dynamically varying range, to discard the hash value. The signature storage circuitry is configured to store an occurrence count indicative of repeat occurrences of each stored hash value. The apparatus is provided with calculation circuitry to estimate a frequently occurring portion of the values based on stored hash values for which the occurrence count meets a condition.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
hash circuitry configured, in response to receipt of a set of values, to generate a set of hash values;
signature storage circuitry configured to store signature data indicative of a subset of the set of hash values, wherein the signature storage circuitry is responsive to receipt of a hash value of the set of hash values:
   when the hash value falls within a dynamically varying range defined at least in part based on the subset, to retain the hash value in the subset and to discard an existing member of the subset; and
   when the hash value does not fall within the dynamically varying range, to discard the hash value,
wherein the signature storage circuitry is configured to store, for each stored hash value of the subset, an occurrence count indicative of a number of repeat occurrences of the stored hash value that occur in the set of hash values during a period in which the stored hash value is retained in the subset; and
calculation circuitry configured to calculate an estimate of a frequently occurring portion of the set of values based on stored hash values for which the occurrence count meets a predetermined condition.
   Clause 2. The apparatus of clause 1, wherein:
the signature data is second signature data, the subset is a second subset, and the second signature data is stored during a second access window;
the signature storage circuitry is configured to store first signature data indicative of a first subset of the set of hash values during a first access window; and
the calculation circuitry is configured to calculate the estimate based on comparison of the first signature data and the second signature data.
   Clause 3. The apparatus of clause 2, wherein a start of the second access window begins after a start of the first access window and at least a portion of the second access window overlaps with the first access window.
   Clause 4. The apparatus of clause 2 or clause 3, wherein first signature data is independent of a number of repeat occurrences of hash values retained in the first subset.
   Clause 5. The apparatus of clause 2 or clause 4, wherein the estimate is based on an intersection size of an intersection of the second subset of hash values for which the occurrence count meets the predetermined condition and the first subset of hash values.
   Clause 6. The apparatus of clause 5, comprising cardinality estimation circuitry configured to calculate a cardinality estimate of the set of values, wherein the estimate comprises multiplying the cardinality estimate by a ratio of the intersection size and a size of the first subset.
   Clause 7. The apparatus of clause 6, wherein:
the cardinality estimation circuitry is configured to calculate a first cardinality estimate at the start of the second access window, and a second cardinality estimate at the end of the second access window; and
the calculation circuitry is configured to estimate a number of newly received values based on a difference between the first cardinality estimate and the second cardinality estimate.
   Clause 8. The apparatus of clause 7, wherein:
the signature storage circuitry is configured to discard a plurality of hash values based on the number of newly received values; and
a number of hash values discarded is based on the number of newly received values divided by the second estimate of cardinality.
   Clause 9. The apparatus of any preceding clause, wherein the signature storage circuitry is configured to evict hash values based on a comparison between the occurrence count and a threshold for each one of the hash values.
   Clause 10. The apparatus of clause 9, comprising an access counter, wherein the signature storage circuitry is configured to store, for each stored hash value of the subset, a snapshot of the access counter,
wherein the calculation circuitry is configured, for each one of the hash values, to perform the comparison based on a difference between the access counter and the snapshot for that one of the hash values.
   Clause 11. The apparatus of clause 9 or clause 10, wherein the signature storage circuitry is configured to evict hash values for which a ratio between the occurrence count and a difference between the snapshot and the access counter is less than the threshold.
   Clause 12. The apparatus of clause 11, wherein evicting hash values comprises setting the hash value to one of:
a predetermined constant, the predetermined constant numerically furthest outside of the dynamically varying range; and
an invalid value.
   Clause 13. The apparatus of any preceding clause, wherein the set of values is a set of accessed memory addresses, and the frequently occurring portion is a set of frequently accessed memory addresses.
   Clause 14. The apparatus of any preceding clause, wherein at least one of an upper bound and a lower bound of the dynamically varying range is defined based on an extremum of the subset.
   Clause 15. The apparatus of clause 14, wherein the existing member of the subset is the extremum of the subset.
   Clause 16. The apparatus of clause 14 or clause 15, wherein the other one of the upper bound and the lower bound is defined based on an extremum of all possible hash values.
   Clause 17. An apparatus comprising:
hash circuitry configured, in response to receipt of a set of values, to generate a set of hash values;
signature storage circuitry configured to store first signature data indicative of a first subset of the set of hash values during a first access window and second signature data indicative of a second subset of the hash values during a second access window, wherein during each respective access window of the first and second access windows the signature storage circuitry is responsive to receipt of a hash value of the set of hash values:
   when the hash value falls within a dynamically varying range defined at least in part based on the respective subset, to retain the hash value in the respective subset and to discard an existing member of the respective subset; and
   when the hash value does not fall within the dynamically varying range, to discard the hash value; and
calculation circuitry configured to calculate an estimate of a recently occurring portion of the set of values based on comparison of the first signature data and the second signature data,
wherein a start of the second access window begins after a start of the first access window and at least a portion of the second access window overlaps with the first access window.
   Clause 18. A system comprising:
the apparatus of any preceding clause, implemented in at least one packaged chip;
at least one system component; and
a board,
wherein the at least one packaged chip and the at least one system component are assembled on the board.
   Clause 19. A chip-containing product comprising the system of clause 18, wherein the system is assembled on a further board with at least one other product component.
   Clause 20. A method comprising:
generating, in response to receipt of set of values, a set of hash values;
storing signature data indicative of a subset of the set of hash values, wherein storing comprises, in response to receipt of a hash value of the set of hash values:
   when the hash value falls within a dynamically varying range defined at least in part based on the subset, retaining the hash value in the subset and discarding an existing member of the subset; and
   when the hash value does not fall within the dynamically varying range, discarding the hash value,
storing, for each stored hash value of the subset, an occurrence count indicative of a number of repeat occurrences of the stored hash value that occur in the set of hash values during a period in which the stored hash value is retained in the subset; and
calculating an estimate of a frequently occurring portion of the set of values based on stored hash values for which the occurrence count meets a predetermined condition.
   Clause 21. A method comprising:
generating, in response to receipt of a set of values, a set of hash values;
storing first signature data indicative of a first subset of the set of hash values during a first access window and second signature data indicative of a second subset of the hash values during a second access window;
during each respective access window of the first and second access windows in response to receipt of a hash value of the set of hash values:
   when the hash value falls within a dynamically varying range defined at least in part based on the respective subset, retaining the hash value in the respective subset and discarding an existing member of the respective subset; and
   when the hash value does not fall within the dynamically varying range, discarding the hash value; and
calculating an estimate of a recently occurring portion of the set of values based on comparison of the first signature data and the second signature data,
wherein a start of the second access window begins after a start of the first access window and at least a portion of the second access window overlaps with the first access window.
   Clause 22. A non-transitory computer-readable medium storing computer-readable code for fabrication of the apparatus of any of clauses 1 to 17.

We claim:

1. An apparatus comprising:
hash circuitry configured, in response to receipt of a set of values, to generate a set of hash values;
signature storage circuitry configured to store signature data indicative of a subset of the set of hash values, wherein the signature storage circuitry is responsive to receipt of a hash value of the set of hash values:
when the hash value falls within a dynamically varying range defined at least in part based on the subset, to retain the hash value in the subset and to discard an existing member of the subset; and
when the hash value does not fall within the dynamically varying range, to discard the hash value,
wherein the signature storage circuitry is configured to store, for each stored hash value of the subset, an occurrence count indicative of a number of repeat occurrences of the stored hash value that occur in the set of hash values during a period in which the stored hash value is retained in the subset; and
calculation circuitry configured to calculate an estimate of a frequently occurring portion of the set of values based on stored hash values for which the occurrence count meets a predetermined condition.

2. The apparatus of claim 1, wherein:
the signature data is second signature data, the subset is a second subset, and the second signature data is stored during a second access window;
the signature storage circuitry is configured to store first signature data indicative of a first subset of the set of hash values during a first access window; and
the calculation circuitry is configured to calculate the estimate based on comparison of the first signature data and the second signature data.

3. The apparatus of claim 2, wherein a start of the second access window begins after a start of the first access window and at least a portion of the second access window overlaps with the first access window.

4. The apparatus of claim 2, wherein first signature data is independent of a number of repeat occurrences of hash values retained in the first subset.

5. The apparatus of claim 2, wherein the estimate is based on an intersection size of an intersection of the second subset of hash values for which the occurrence count meets the predetermined condition and the first subset of hash values.

6. The apparatus of claim 5, comprising cardinality estimation circuitry configured to calculate a cardinality estimate of the set of values, wherein the estimate comprises multiplying the cardinality estimate by a ratio of the intersection size and a size of the first subset.

7. The apparatus of claim 6, wherein:
the cardinality estimation circuitry is configured to calculate a first cardinality estimate at the start of the second access window, and a second cardinality estimate at the end of the second access window; and
the calculation circuitry is configured to estimate a number of newly received values based on a difference between the first cardinality estimate and the second cardinality estimate.

8. The apparatus of claim 7, wherein:
the signature storage circuitry is configured to discard a plurality of hash values based on the number of newly received values; and
a number of hash values discarded is based on the number of newly received values divided by the second estimate of cardinality.

9. The apparatus of claim 1, wherein the signature storage circuitry is configured to evict hash values based on a comparison between the occurrence count and a threshold for each one of the hash values.

10. The apparatus of claim 9, comprising an access counter, wherein the signature storage circuitry is configured to store, for each stored hash value of the subset, a snapshot of the access counter,
wherein the calculation circuitry is configured, for each one of the hash values, to perform the comparison based on a difference between the access counter and the snapshot for that one of the hash values.

11. The apparatus of claim 9, wherein the signature storage circuitry is configured to evict hash values for which a ratio between the occurrence count and a difference between the snapshot and the access counter is less than the threshold.

12. The apparatus of claim 11, wherein evicting hash values comprises setting the hash value to one of:
a predetermined constant, the predetermined constant numerically furthest outside of the dynamically varying range; and
an invalid value.

13. The apparatus of claim 1, wherein the set of values is a set of accessed memory addresses, and the frequently occurring portion is a set of frequently accessed memory addresses.

14. The apparatus of claim 1, wherein at least one of an upper bound and a lower bound of the dynamically varying range is defined based on an extremum of the subset.

15. The apparatus of claim 14, wherein the existing member of the subset is the extremum of the subset.

16. An apparatus comprising:
hash circuitry configured, in response to receipt of a set of values, to generate a set of hash values;
signature storage circuitry configured to store first signature data indicative of a first subset of the set of hash values during a first access window and second signature data indicative of a second subset of the hash values during a second access window, wherein during each respective access window of the first and second access windows the signature storage circuitry is responsive to receipt of a hash value of the set of hash values:
when the hash value falls within a dynamically varying range defined at least in part based on the respective subset, to retain the hash value in the respective subset and to discard an existing member of the respective subset; and
when the hash value does not fall within the dynamically varying range, to discard the hash value; and
calculation circuitry configured to calculate an estimate of a recently occurring portion of the set of values based on comparison of the first signature data and the second signature data,
wherein a start of the second access window begins after a start of the first access window and at least a portion of the second access window overlaps with the first access window.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
generating, in response to receipt of set of values, a set of hash values;
storing signature data indicative of a subset of the set of hash values, wherein storing comprises, in response to receipt of a hash value of the set of hash values:
when the hash value falls within a dynamically varying range defined at least in part based on the subset, retaining the hash value in the subset and discarding an existing member of the subset; and
when the hash value does not fall within the dynamically varying range, discarding the hash value,
storing, for each stored hash value of the subset, an occurrence count indicative of a number of repeat occurrences of the stored hash value that occur in the set of hash values during a period in which the stored hash value is retained in the subset; and
calculating an estimate of a frequently occurring portion of the set of values based on stored hash values for which the occurrence count meets a predetermined condition.

20. A non-transitory computer-readable medium storing computer-readable code for fabrication of the apparatus of claim 1.
